(19) United States
(12) Patent Application Publication
(10) Pub. No.: US 2011/0090162 A1
(43) Pub. Date: Apr. 21, 2011

(54) DISPLAY APPARATUS AND TOUCH DISPLAY APPARATUS

(75) Inventor: PO-SHENG SHIH, Miao-Li County (TW)

(73) Assignee: CHIMEI INNOLUX CORPORATION, Miao-Li County (TW)

(21) Appl. No.: 12/901,559

(22) Filed: Oct. 10, 2010

(30) Foreign Application Priority Data
Oct. 16, 2009 (CN) 200910308353.7

(51) Int. Cl. G06F 3/041; G02F 1/1333

(52) U.S. Cl. 345/173; 349/56

(57) ABSTRACT

A display apparatus includes a first substrate, a first conductive layer, a second substrate, a second conductive layer, a containing unit and a plurality of charged particles. The first conductive layer has anisotropic impedance and is disposed on the first substrate. The second conductive layer is disposed on the second substrate. The containing unit is disposed between the first conductive layer and the second conductive layer and includes a plurality of pixel spaces. The plurality of charged particles are filled in the pixel spaces.

### BACKGROUND OF THE DISCLOSURE

1. Field of the Disclosure

The disclosure relates to a display apparatus, and particularly, to a display apparatus and a touch display apparatus.

2. Description of Related Art

Generally, electronic paper display technologies include electrophoresis, electronic powders, charged polymer particles, cholesteric liquid crystals, electrowetting technologies, and so on.

Specifically, the above electronic paper includes a front plane laminate (FPL), a transistor array substrate, and a display array disposed between the FPL and the transistor array substrate. Taking the electrophoretic electronic paper technology as an example, the display array is formed by a plurality of micro-capsules, and each of the micro-capsules contains black liquid and white charged particles. When the electrical field between each pixel electrode of the transistor array substrate and a common electrode layer is changed, the white charged particles are moved upwards (i.e. approaching readers) or moved downwards according to the direction of the electrical field, thus making each pixel be white or black, so as to achieve displaying.

Along maturation of technology, the electronic paper has caught attention of many companies, and many large companies have participated in their development. In the feature, the requirements of the markets for the electronic paper tend to be light, thin, and easy to carry, and have high display quality. Therefore, it is an important subject in the area to manufacture an electronic paper having flexibility and more gray levels.

### SUMMARY OF THE DISCLOSURE

An embodiment of the disclosure provides a display apparatus including a first substrate, a first conductive layer, a second substrate, a second conductive layer, a containing unit, and a plurality of charged particles. The first conductive layer has anisotropic impedance and is disposed on the first substrate; The second conductive layer is disposed on the second substrate. The containing unit is disposed between the first conductive layer and the second conductive layer and includes a plurality of pixel spaces. The charged particles are filled in the pixel spaces.

Another embodiment of the disclosure provides a touch display apparatus including a flexible display panel and a touch panel. The touch panel is disposed on the flexible display panel and includes a third substrate, a third conductive layer, a fourth substrate, and a fourth conductive layer. The third conductive layer is disposed on the third substrate and has anisotropic impedance. The fourth substrate is disposed opposite to the third substrate. The fourth conductive layer is disposed on the fourth substrate.

In order to make the aforementioned and other features and advantages of the disclosure more comprehensible, embodiments accompanying figures are described in detail below.

### BRIEF DESCRIPTION OF THE DRAWINGS

The accompanying drawings are included to provide a further understanding of the disclosure and are incorporated in and constitute a part of this specification. The drawings illustrate embodiments of the disclosure and, together with the description, serve to explain the principles of the disclosure.

FIG. 1A is a schematic cross-sectional view of a display apparatus according to the first embodiment of the disclosure.

FIG. 1B is a top view of the first conductive layer of FIG. 1A.

FIG. 2A is a schematic cross-sectional view of a display apparatus according to the second embodiment of the disclosure.

FIG. 2B is a top view of the second conductive layer of FIG. 2A.

FIG. 3 is a cross-sectional view of a display apparatus according to the third embodiment of the present disclosure.

FIG. 4A is a schematic cross-sectional view of a touch display apparatus according to the fourth embodiment of the disclosure.

FIG. 4B is a schematic view of the third substrate and the fourth substrate of the touch panel in FIG. 4A.

FIG. 5A is a schematic cross-sectional view of a touch display apparatus according to the fourth embodiment of the disclosure.

FIG. 5B is a schematic view of the third substrate and the fourth substrate of the touch panel in FIG. 5A.

FIG. 6 is a schematic cross-sectional view of a touch display apparatus according to the sixth embodiment of the disclosure.

FIG. 7 is a schematic cross-sectional view of a touch display apparatus according to the seventh embodiment of the disclosure.

FIG. 8 is a schematic view of a display apparatus according to the eighth embodiment of the disclosure.

### DESCRIPTION OF EMBODIMENTS

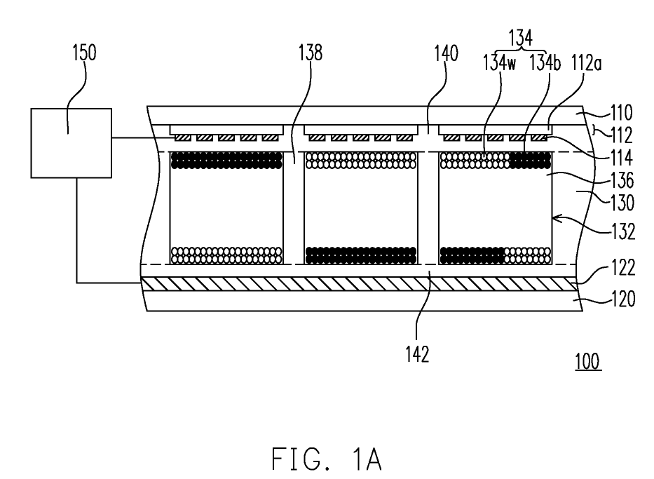

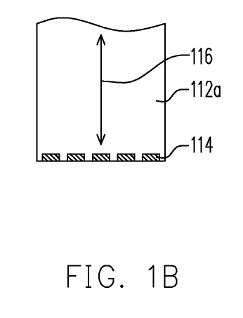

FIG. 1A is a schematic cross-sectional view of a display apparatus according to the first embodiment of the disclosure. FIG. 1B is a top view of the first conductive layer of FIG. 1A.

Referring to FIG. 1A, the display apparatus 100 includes a first substrate 110, a first conductive layer 112, a second substrate 120, a second conductive layer 122, a containing unit 130, a dielectric solvent 136, and a plurality of charged particles 134. The first conductive layer 112 has anisotropic impedance and is disposed on the first substrate 110. The second conductive layer 122 is disposed on the second substrate 120. The containing unit 130 is disposed between the first conductive layer 112 and the second conductive layer 122 and includes a plurality of pixel spaces 132. The dielectric solvent 136 is filled in the pixel spaces 132. The plurality of charged particles 134 are filled in the pixel spaces 132. In this embodiment, the display apparatus 100 further includes a driving unit 150 electrically connected to the first conductive layer 112 and the second conductive layer 122.

Referring to both FIGS. 1A and 1B, in this embodiment, the first substrate 110 is, for example, a transparent substrate, and the first substrate 110 and the second substrate 120 are, for example, flexible substrates. However, in other embodiments, the first substrate 110 and the second substrate 120 may be rigid substrates. The first conductive layer 112 is, for example, a carbon nanotube film having flexibility and anisotropic impedance. The first conductive layer 112 includes a plurality of conductive blocks 112a respectively disposed above the pixel spaces 132, and the conductive blocks 112a are separated from each other. Each of the conductive blocks 112a has a main conductive direction 116. A plurality of electrodes 114 are connected to a side of each of the conductive blocks 112a. The electrodes 114 are arranged along a direction substantially perpendicular to the main conductive direction 116. It should be noted that in this embodiment, the main conductive direction 116 is a direction along which the impedance of the conductive block 112a is smallest, perpendicular to which the impedance of the conductive block 112a is largest. Specifically, there are a plurality of carbon nanotubes extending substantially along the main conductive direction 116 in each conductive block 112a. The carbon nanotube has the property that the impedance thereof is smaller along the extending direction thereof and is larger along the radial direction. However, in other embodiments, other nano-units having anisotropic impedance are used to replace the carbon nanotubes. The second conductive layer 122 is, for example, a light transmissive conductive layer or an opaque conductive layer, and is preferably a metal thin film having flexibility.

Referring to FIG. 1A, the containing unit 130 includes the pixel spaces 132, a wall portion 138, a first insulation portion 140, and a second insulation portion 142. The wall portion 138 is disposed between any two adjacent pixel spaces 132 to separate the pixel spaces 132. The first insulation portion 140 is disposed between the pixel spaces 132 and the first conductive layer 112 to insulate the pixel spaces 132 from the first conductive layer 112. The second insulation portion 142 is disposed between the pixel spaces 132 and the second conductive layer 122 to insulate the pixel spaces 132 from the second conductive layer 122. The wall portion 138, the first insulation portion 140, and the second insulation portion 142 may be connected together and be a integrally formed structure, or be individually formed elements.

The charged particles 134 and the dielectric solvent 136 are filled in the pixel spaces 132. The charged particles 134 are dispersedly distributed in the dielectric solvent 136, and capable of moving in the dielectric solvent 136. In this embodiment, the charged particles 134 include white positively charged particles 134w and black negatively charged particles 134b, and the dielectric solvent 136 is, for example, colorless liquid. The dielectric solvent 136 may be a solvent or a solvent mixture selected from a group consisting of hydrocarbon, alkyl ketone, alkyl ester, alcohol, ether, water, and the mixtures thereof. Besides, in other embodiments, the color of the dielectric solvent 136 may be black, white, or another color. Moreover, in another embodiment, the white charged particles are negatively charged, and the black charged particles are positively charged. Alternatively, in yet another embodiment, the charged particles 134 may be colored charged particles other than black or white charged particles and may be, for example, at least one of red charged particles, green charged particles, and blue charged particles. In this way, there may be no color filter units disposed in the display apparatus. In addition, it is taken as an example in this embodiment that a part of the charged particles 134w are positively charged, and the other part of the charged particles 134b are negatively charged. However, in other embodiments, all of the charged particles 134 may be positively charged or negatively charged.

As showed in FIG. 1A, the driving unit 150 transmits signals through the first conductive layer 112 and the second conductive layer 122 to two opposite sides of the corresponding pixel spaces 132, such that a voltage difference is generated between the two opposite sides of the pixel spaces 132. In this way, the white charged particles 134w and the black charged particles 134b move to the top or bottom of the pixel spaces 132 according to the voltage difference between the two opposite sides of the pixel spaces 132, so as to achieve the effect of displaying a frame. In detail, in this embodiment, the first conductive layer 112 has anisotropic impedance and includes a plurality of conductive blocks 112a. Therefore, the voltage differences between the two opposite sides of the pixel spaces 132 are respectively generated by applying different voltages to different conductive blocks 112a or selectively applying or not applying voltages to different portions of each conductive blocks 112a, thus further rendering each pixel spaces 132 to have different gray levels. For example, as shown by the most right conductive block 112a in FIG. 1A, a plurality of electrodes 114 are connected to a side of each conductive block 112a. Therefore, a plurality of voltage differences are generated between two opposite sides of a same pixel space 132 by applying different voltages to the electrodes 114, or selectively applying or not applying voltages, thus further rendering a single pixel space 132 to have more gray levels.

It should be noted that in this embodiment, a electrophoretic display apparatus having the dielectric solvent 136 is taken as an example. However, in another embodiment, the display apparatus 100 may be a powder type display apparatus. In other words, the dielectric solvent 136 in the pixel spaces 132 is replaced by gas or air, and powder type charged particles 134 is moved in the gas or air, so as to perform displaying.

In this embodiment, since the first conductive layer 112 has anisotropic impedance, the displaying of each pixel space 132 is controlled by applying different voltages to the first conductive layer 112 corresponding to each pixel spaces 132, thus rendering the display apparatus 100 to have more gray levels. In addition, the first conductive layer 112 is a carbon nanotube film in this embodiment, the carbon nanotube film not only has anisotropic impedance, but also can be bent to have a greater curvature without breaking compared with general indium tin oxide or other transparent conductive materials. Moreover, the carbon nanotube film has better durability for repeatedly bending and a lower cost. Therefore, the manufactured display apparatus 100 has flexibility to be easy to store and carry, better reliability, and a lower manufacture cost.

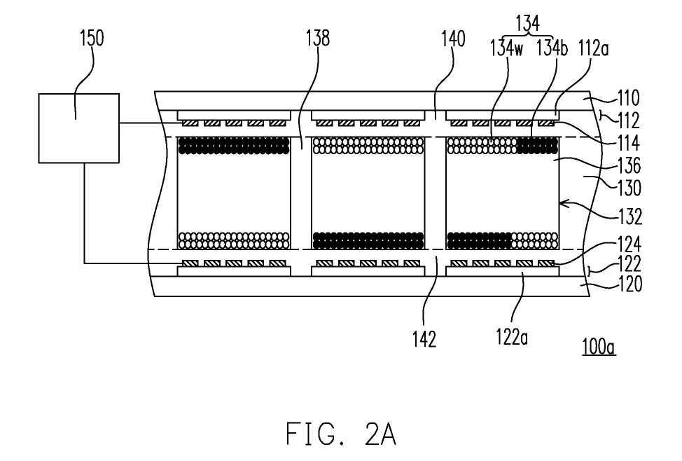

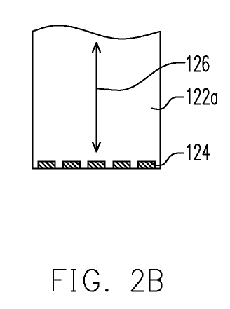

FIG. 2A is a schematic cross-sectional view of a display apparatus according to the second embodiment of the disclosure. FIG. 2B is a top view of the second conductive layer of FIG. 2A.

Referring to both FIGS. 2A and 2B, in this embodiment, the structure and displaying method of the display apparatus 100a are similar to those of the display apparatus 100 in the first embodiment, and the main difference lies in that both the first conductive layer 112 and the second conductive layer 122 of the display apparatus 100a have anisotropic impedance. In this embodiment, the second conductive layer 122 is, for example, a carbon nanotube film. The second conductive layer 122 includes a plurality of conductive blocks 122a respectively disposed below the pixel spaces 132, and the conductive blocks 122a are separated from each other. Each of the conductive blocks 122a has a main conductive direction 126. A plurality of electrodes 124 are connected to a side of each of the conductive blocks 122a. The electrodes 124 are arranged along a direction substantially perpendicular to the main conductive direction 126.

Therefore, a plurality of voltage differences are generated between two opposite sides of a same pixel space 132 by applying different voltages to the electrodes 114, 124, or selectively applying or not applying voltages, thus further rendering a single pixel space 132 to have more gray levels.

In this embodiment, since both the first conductive layer 112 and the second conductive layer 122 have anisotropic impedance, it is easier to control and adjust the display apparatus 100a, so as to render the display apparatus 100a to have more gray levels. Additionally, the first conductive layer 112 and the second conductive layer 122 are carbon nanotube films in this embodiment, such that the manufactured display apparatus 100a has better flexibility, better reliability, and lower manufacture cost.

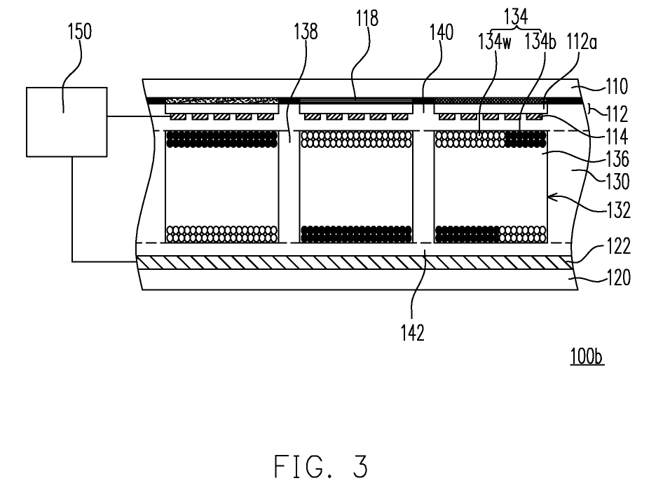

FIG. 3 is a schematic cross-sectional view of a display apparatus according to the third embodiment of the disclosure.

Referring to FIG. 3, in this embodiment, the structure and displaying method of the display apparatus 100b are similar to those of the display apparatus 100 in the first embodiment, and the main difference lies in that the display apparatus 100b further includes a plurality of color filter units 118. The color filter units 118 are disposed between the first substrate 110 and the first conductive layer 112, and respectively located above the pixel spaces 132. The color filter units 118 include red filter films, green filter films and blue filter films. In this way, even though the charged particles 134 include white positively charged particles 134w and black negatively charged particles 134b or include one of the two, the display apparatus 100b can still perform full color displaying.

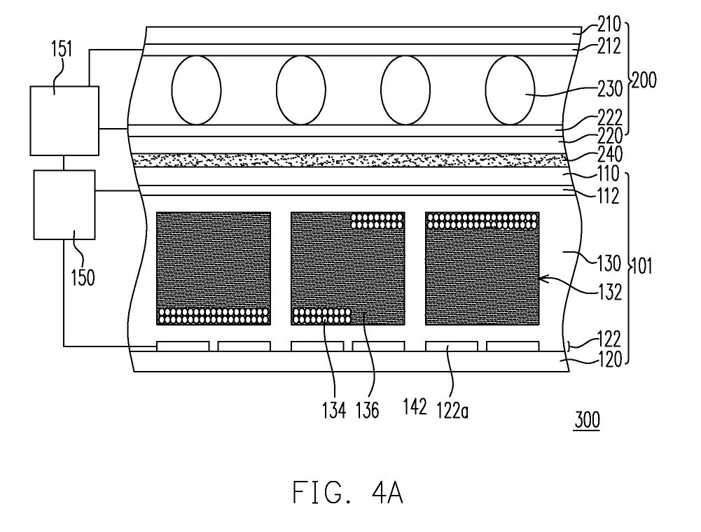

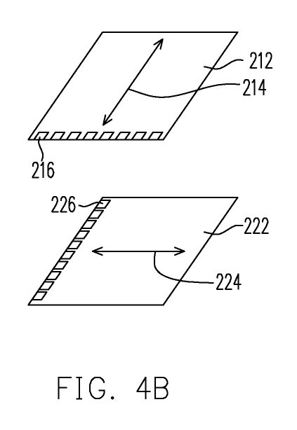

FIG. 4A is a schematic cross-sectional view of a touch display apparatus according to the fourth embodiment of the disclosure. FIG. 4B is a schematic view of the third substrate 210 and the fourth substrate 220 of the touch panel in FIG. 4A.

Referring to FIG. 4A, the touch display apparatus 300 includes a flexible display panel 101, a touch panel 200, an adhesive layer 240, and driving units 150 and 151. The touch panel 200 adheres to the flexible display panel 101 through the adhesive layer 240, for example. The driving unit 151 is electrically connected to the third conductive layer 212 and the fourth conductive layer 222 of the touch panel 200, and the driving unit 150 is electrically connected to the first conductive layer 112 and the second conductive layer 122 of the flexible display panel 101. Moreover, the driving unit 150 is electrically connected to the driving unit 151.

In this embodiment, the flexible display panel 101 is, for example a electrophoretic display apparatus including a first substrate 110, a first conductive layer 112, a second substrate 120, a second conductive layer 122, a containing unit 130, a dielectric solvent 136, and a plurality of charged particles 134. The first conductive layer 112 is disposed on the first substrate 110, and the material of the first conductive layer 112 is, for example, indium tin oxide or another transparent material. The second conductive layer 122 is disposed on the second substrate 120 and includes a plurality of conductive blocks 122a respectively disposed below the pixel spaces 132, wherein the conductive blocks 122a are separated from each other. The conductive blocks 122a are, for example, metal electrodes. The containing unit 130 is disposed between the first conductive layer 112 and the second conductive layer 122 and includes a plurality of pixel spaces 132. The charged particles 134 and the dielectric solvent 136 are filled in the pixel spaces 132. In this embodiment, the charged particles 134 are, for example, white negatively charged particles. The color of the dielectric solvent 136 is, for example, black. The charged particles 134 is capable of moving in the dielectric solvent 136. In detail, the driving unit 150 transmits signals through the first conductive layer 112 and the second conductive layer 122 to two opposite sides of the corresponding pixel spaces 132, such that a voltage difference is generated between the two opposite sides of the pixel spaces 132. In this way, the charged particles 134 move to the top or bottom of the pixel spaces 132 according to the voltage difference between the two opposite sides of the pixel spaces 132, so as to achieve the effect of displaying a frame. It should be noted that in this embodiment, the flexible display panel 101 being a electrophoretic display apparatus is taken as an example. However, the flexible display panel 101 may be any known flexible display panel. For example, the flexible display panel 101 may be a powder type display apparatus. In other words, the dielectric solvent 136 in the pixel spaces 132 is replaced by gas or air, and powder type charged particles 134 is moved in the gas or air, so as to perform displaying.

Referring to both FIGS. 4A and 4B, the touch panel 200 includes a third substrate 210, a third conductive layer 212, a fourth substrate 220, and a fourth conductive layer 222. The third conductive layer 212 is disposed on the third substrate 210 and has anisotropic impedance. The fourth substrate 220 is disposed opposite to the third substrate 210. The fourth conductive layer 222 is disposed on the fourth substrate 220. In this embodiment, the touch panel 200 is, for example, a resistance type touch panel. The touch panel 200 further includes a plurality of spacers 230 disposed between the third conductive layer 212 and the fourth conductive layer 222. It should be noted that although it is taken as an example that the third substrate 210 is an upper substrate and the fourth substrate 220 is a lower substrate in this embodiment, the third substrate 210 may be a lower substrate and the fourth substrate 220 may be an upper substrate in other embodiments. That is to say, the third conductive layer 212 having anisotropic impedance may be disposed on the upper substrate or the lower substrate.

In this embodiment, the third substrate 210 and the fourth substrate 220 are, for example, flexible substrates, and both the fourth conductive layer 222 and the third conductive layer 212 have anisotropic impedance. The third conductive layer 212 and the fourth conductive layer 222 is, for example, carbon nanotube films having both anisotropic impedance and flexibility. The third conductive layer 212 has a main conductive direction 214, and the fourth conductive layer 222 has a main conductive direction 224. The main conductive direction 214 of the third conductive layer 212 is, for example, perpendicular to the main conductive direction 224 of the fourth conductive layer 222. In this embodiment, a plurality of electrodes 216 separated from each other are disposed at one side of the third conductive layer 212 and along a direction substantially perpendicular to the main conductive direction 214. Besides, a plurality of electrodes 226 separated from each other are disposed at one side of the fourth conductive layer 222 and along a direction substantially perpendicular to the main conductive direction 224.

In this embodiment, the touch display apparatus 300 is a resistance type touch display apparatus. Therefore, when a user touches the touch panel 200, the third conductive layer 212 contacts with the fourth conductive layer 222, such that the voltage signal sensed by the electrodes 212 and 226 is changed. Since both the third conductive layer 212 and the fourth conductive layer 222 have anisotropic impedance, and since the main conductive direction 214 of the third conductive layer 212 is perpendicular to the main conductive direction 224 of the fourth conductive layer 222, the touch panel 200 accurately determines the touch position pressed by the user based on the voltage differences sensed by the plurality of the electrodes 216 and 226. As such, the flexible display panel 101 achieves the touch function according to the selection of the user.

In this embodiment, the touch panel 200 has better positioning accuracy, such that the misjudgement of touch signals is prevented, so as to provide better touch function and render the flexible display panel to perform correct displaying according to the selection of the user. In addition, in this embodiment, since the third substrate 210 and the fourth substrate 220 of the touch panel 200 have flexibility, and since the third conductive layer 212 and the fourth conductive layer 222 include carbon nanotube films having flexibility, the touch panel 200 is combined with the flexible display panel 101 to form the touch display apparatus 300 having flexibility. In other words, the touch display apparatus 300 has better touch and displaying quality, and is easy to store and carry, which meets the requirement of the markets for the display apparatus.

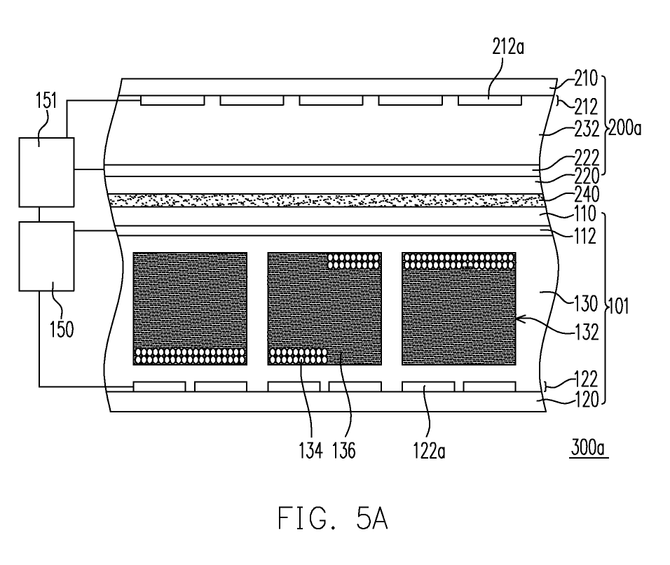

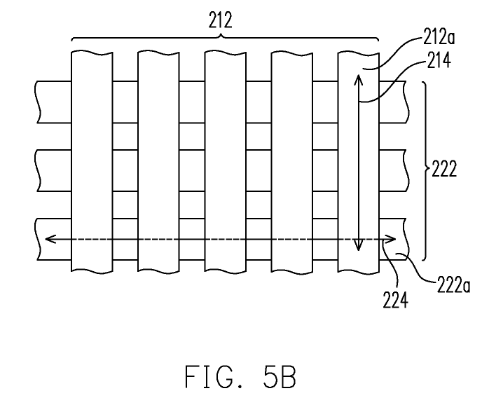

FIG. 5A is a schematic cross-sectional view of a touch display apparatus according to the fifth embodiment of the disclosure. FIG. 5B is a schematic view of the third substrate 210 and the fourth substrate 220 of the touch panel in FIG. 5A. In this embodiment, the structure of the touch display apparatus 300a is similar to that of the display apparatus 300, and the main difference lies in that the touch panel 200a is a capacitance type touch panel. The main difference is described as follows.

Referring to FIGS. 5A and 5B, the touch panel 200a adheres to the flexible display panel 101 through the adhesive layer 240, for example. The touch panel 200a includes a third substrate 210, a third conductive layer 212, a fourth substrate 220, a fourth conductive layer 222, and an insulation layer 232. In this embodiment, the third conductive layer 212 is disposed on the third substrate 210 and has anisotropic impedance. For example, the third conductive layer 212 includes a plurality of conductive blocks 212a separated from each other. The conductive blocks 212a are, for example, carbon nanotube films. The conductive blocks 212a are arranged parallel to each other and extend along its main conductive direction 214. The fourth conductive layer 222 is disposed on the fourth substrate 220 and has anisotropic impedance. For example, the fourth conductive layer 222 includes a plurality of conductive blocks 222a separated from each other. The conductive blocks 222a are, for example, carbon nanotube films. The conductive blocks 222a are arranged parallel to each other and extend along its main conductive direction 224. In addition, in this embodiment, the arrangement direction of the conductive blocks 212a is, for example, perpendicular to the arrangement direction of the conductive blocks 222a. Therefore, the main conductive direction 214 of the conductive blocks 212a is, for example, perpendicular to the main conductive direction 224 of the conductive blocks 222a. The insulation layer 232 is disposed between the third conductive layer 212 and the fourth conductive layer 222. It should be noted that although it is taken as an example that the third substrate 210 is an upper substrate and the fourth substrate 220 is an lower substrate in this embodiment, the third substrate 210 may be a lower substrate and the fourth substrate 220 may be an upper substrate in other embodiments.

In this embodiment, the touch display apparatus 300a is a capacitance type touch display apparatus. Therefore, when a user touches the touch panel 200a, the capacitance changing is sensed by the third conductive layer 212 and the fourth conductive layer 222. Since both the third conductive layer 212 and the fourth conductive layer 222 have anisotropic impedance, and since the main conductive direction 214 of the third conductive layer 212 is perpendicular to the main conductive direction 224 of the fourth conductive layer 222, the touch panel 200a accurately determines the touch position pressed by the user. As such, the flexible display panel 101 changes displayed frames according to the selection of the user.

In this embodiment, the touch display apparatus 300a has better positioning accuracy, such that the misjudgement of touch signals is prevented, so as to provide better touch function and render the flexible display panel to perform correct displaying according to the selection of the user. In addition, in this embodiment, since the third substrate 210 and the fourth substrate 220 of the touch panel 200a have flexibility, and since the third conductive layer 212 and the fourth conductive layer 222 include carbon nanotube films having flexibility, the touch panel 200a is combined with the flexible display panel 101 to form the touch display apparatus 300a having flexibility. In other words, the touch display apparatus 300a has better touch and displaying quality, and is easy to store and carry, which meets the requirement of the markets for the display apparatus.

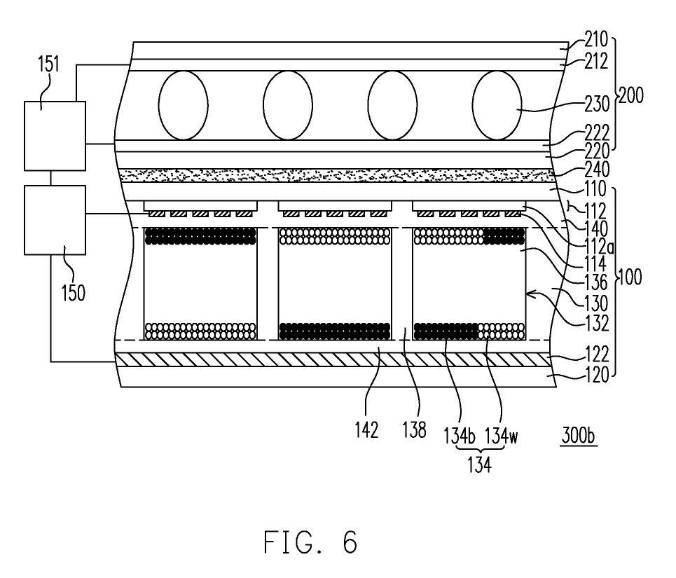

FIG. 6 is a cross-sectional view of a touch display apparatus according to the sixth embodiment of the present disclosure.

Referring to FIG. 6, in this embodiment, the structure of the touch display apparatus 300b is similar to that of the display apparatus 300 in the fourth embodiment, and the main difference lies in that the display apparatus 100 in the first embodiment is used as a flexible display panel in this embodiment. That is to say, the touch panel 200 is combined to the display apparatus 100 in this embodiment. The structures of the display apparatus 100 and the touch panel 200 and the combination method of the two can refer to the descriptions in the first embodiment and the fourth embodiment, and are not repeated herein. Moreover, in another embodiment, the touch panel 200a may be combined to the display apparatus 100 to form a capacitance type touch display apparatus (not shown), and the relative descriptions can refer to those in the fifth embodiment and the first embodiment, and are not repeated herein. Furthermore, in yet another embodiment, a typical touch panel (not shown) may be combined to the display apparatus 100 to form a touch display apparatus (not show). In other words, the structure of the touch panel is similar to that of the touch panel 200, but the third conductive layer 212 and the fourth conductive layer 222 of this touch panel do not have anisotropic impedance.

Since the touch display apparatus 300b includes display apparatus 100 having more gray levels and the touch panel 200 having good positioning accuracy, the touch display apparatus 300b has better touch and displaying quality. Besides, when the first conductive layer 112 of the display apparatus 100 and the third conductive layer 212 and the fourth conductive layer 222 of the touch panel 200 are carbon nanotube films, the flexibility of the touch display apparatus 300b is good. Therefore, the touch display apparatus 300b has flexibility to be easy to store and carry, better reliability, and a lower manufacture cost.

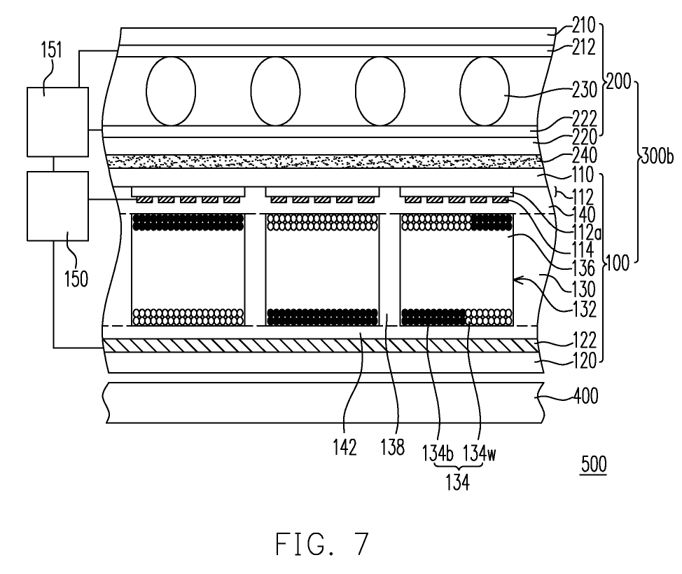

FIG. 7 is a cross-sectional view of a touch display apparatus according to the seventh embodiment of the disclosure.

Referring to FIG. 7, in this embodiment, a touch display apparatus 500 is formed by disposing a backlight module 400 below the touch display apparatus 300b in the sixth embodiment. The backlight module 400 is, for example, an organic light emitting diode (OLED) having flexibility. In this way, since the touch display apparatus 500 has backlight, it can still perform displaying even in the environment lacking light source, so as to increase the applications of the touch display apparatus 500. In other embodiments, the OLED may be replaced by another backlight module having flexibility.

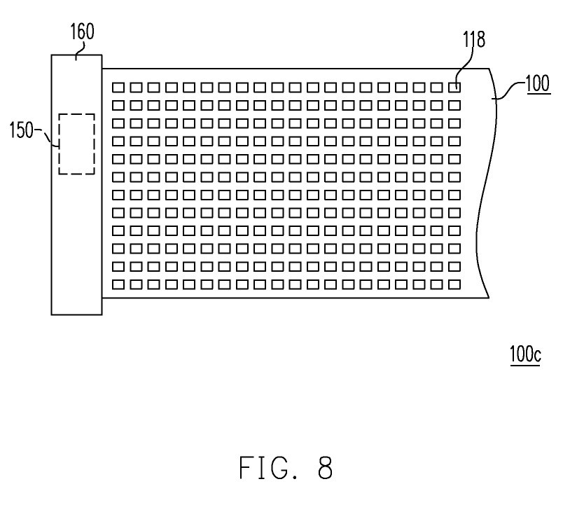

FIG. 8 is a schematic view of a display apparatus according to the eighth embodiment of the disclosure.

Referring to FIG. 8, in this embodiment, the structure of the display apparatus 100c is similar to that of the display apparatus 100 in the first embodiment, and the main difference lies in that the display apparatus 100c further includes a scroll 160. The driving unit 150 is disposed in the scroll 160. In this way, the driving unit 150 disposed in the rigid scroll 160 may get better protection and higher design flexibility. The display apparatus 100c is easy to carry due to scrolling the display apparatus 100c by the scroll 160, and also has the property of a flexible display apparatus. Of course, according to the requirement of the product, the scroll 160 may also be disposed in other display apparatus 100a, 100b, or the powder type display apparatus (not shown). As such, the display apparatus not only has more gray levels, but also is easy to store or carry, so as to meet the requirement of the markets for the display apparatus.

In view of the above, there is a conductive layer having anisotropic impedance in the display apparatus and the touch display apparatus according to the embodiments of the disclosure. As a result, in the display apparatus, the displaying of each pixel spaces is controlled to render the display apparatus to have more gray levels by applying different voltages or selectively applying or not applying voltages to each portion of the conductive layer having anisotropic impedance and corresponding to each pixel space. On the other hand, in the touch display apparatus, the touch panel includes a conductive layer having anisotropic impedance, such that the touch panel has better positioning accuracy, which prevents misjudgement of touch signals, so as to provide better touch and displaying quality.

In addition, when the conductive layer of the display apparatus and the touch display apparatus are made of the material having both anisotropic impedance and flexibility, such as the carbon nanotube film, the display apparatus and the touch display apparatus have better flexibility. As such, the display apparatus and the touch display apparatus are easy to store or carry, so as to meet the requirement of the markets for the display apparatus.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A display apparatus, comprising:
a first substrate;
a first conductive layer, having anisotropic impedance and disposed on the first substrate;
a second substrate;
a second conductive layer, disposed on the second substrate;
a containing unit, disposed between the first conductive layer and the second conductive layer and comprising a plurality of pixel spaces; and
a plurality of charged particles, filled in the pixel spaces.

2. The display apparatus as claimed in claim 1, wherein the first conductive layer is a carbon nanotube film.

3. The display apparatus as claimed in claim 1, wherein the first conductive layer comprises a plurality of conductive blocks respectively disposed above the pixel spaces, the conductive blocks are separated from each other, each of the conductive blocks has a main conductive direction, a plurality of electrodes are connected to a side of each of the conductive blocks, and the electrodes are arranged along a direction substantially perpendicular to the main conductive direction.

4. The display apparatus as claimed in claim 1, wherein the second conductive layer has anisotropic impedance.

5. The display apparatus as claimed in claim 4, wherein the second conductive layer is a carbon nanotube film.

6. The display apparatus as claimed in claim 4, wherein the second conductive layer comprises a plurality of conductive blocks respectively disposed below the pixel spaces, the conductive blocks are separated from each other, each of the conductive blocks has a main conductive direction, a plurality of electrodes are connected to a side of each of the conductive blocks, and the electrodes are arranged along a direction substantially perpendicular to the main conductive direction.

7. The display apparatus as claimed in claim 1, wherein the first substrate and the second substrate are flexible substrates.

8. The display apparatus as claimed in claim 1, wherein the charged particles in each of the pixel spaces are positively charged or negatively charged, or a part of the charged particles in each of the pixel spaces are positively charged and the other part of the charged particles are negatively charged.

9. The display apparatus as claimed in claim 1, wherein the charged particles comprises at least one of white charged particles, black charged particles, and colored charged particles.

10. The display apparatus as claimed in claim 1, further comprising a dielectric solvent filled in the pixel spaces.

11. The display apparatus as claimed in claim 10, wherein color of the dielectric solvent is colorless, black, or white.

12. The display apparatus as claimed in claim 1, wherein the containing unit comprises a wall portion, disposed between any two adjacent pixel spaces for separating the pixel spaces.

13. The display apparatus as claimed in claim 1, further comprising a plurality of color filter units disposed on the first substrate and respectively located above the pixel spaces.

14. The display apparatus as claimed in claim 1, further comprising a driving unit, electrically connected to the first conductive layer and the second conductive layer, wherein the driving unit is adapted to transmit a signal through the first conductive layer and the second electrically layer to two opposite sides of the corresponding pixel spaces, so as to drive the charged particles in the pixel spaces to perform displaying.

15. The display apparatus according to claim 1, further comprising a backlight module, wherein the second substrate is disposed between the first substrate and the backlight module.

16. The display apparatus according to claim 1, further comprising a touch panel disposed on the first substrate, wherein the first substrate is disposed between the touch panel and the second substrate, and the touch panel comprises:
a third substrate;
a third conductive layer, disposed on the third substrate;
a fourth substrate, disposed opposite to the third substrate; and
a fourth conductive layer, disposed on the fourth substrate.

17. The display apparatus as claimed in claim 16, wherein both the third conductive layer and the fourth conductive layer have anisotropic impedance.

18. A touch display apparatus, comprising:
a flexible display panel; and
a touch panel, disposed on the flexible display panel and comprising:
a third substrate;
a third conductive layer, disposed on the third substrate and having anisotropic impedance;
a fourth substrate, disposed opposite to the third substrate; and
a fourth conductive layer, disposed on the fourth substrate.

19. The touch display apparatus as claimed in claim 18, wherein the third conductive layer comprises a carbon nanotube film.

20. The touch display apparatus as claimed in claim 18, wherein the fourth conductive layer has anisotropic impedance.

21. The touch display apparatus as claimed in claim 18, wherein the flexible display panel comprises:
a first substrate;
a first conductive layer, having anisotropic impedance and disposed on the first substrate;
a second substrate;
a second conductive layer, disposed on the second substrate;
a containing unit, disposed between the first conductive layer and the second conductive layer and comprising a plurality of pixel spaces; and
a plurality of charged particles, filled in the pixel spaces.

22. The touch display apparatus as claimed in claim 21, wherein the flexible display panel further comprises a dielectric solvent filled in the pixel spaces.
